(19) United States
(12) Patent Application Publication
(10) Pub. No.: US 2026/0253314 A1
(43) Pub. Date: Aug. 27, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: TOMOHIRO OOI, TOKYO (JP)

(21) Appl. No.: 18/871,206

(22) PCT Filed: May 24, 2023
(86) PCT No.: PCT/JP2023/019249

§ 371 Date: Dec. 3, 2024

(30) Foreign Application Priority Data
Jun. 10, 2022 (JP) 2022-094436

(51) Int. Cl. G06T 15/20; G06T 7/70; G06T 13/40

(52) U.S. Cl. CPC G06T 15/20; G06T 7/70; G06T 13/40

(57) ABSTRACT

An information processing device includes a virtual viewpoint video generation unit, a posture estimation unit, an avatar generation unit, an image comparison unit, and a correction unit. The virtual viewpoint video generation unit uses shooting data of a subject captured from a plurality of viewpoints to generate a virtual viewpoint video of the subject when the subject is viewed from a virtual viewpoint. The posture estimation unit uses the shooting data to estimate a posture of the subject. The avatar generation unit generates an avatar model having a 3D shape of the subject corresponding to the posture. The avatar generation unit renders an avatar model on the basis of the virtual viewpoint to generate an avatar. The image comparison unit extracts a difference between the virtual viewpoint video and the avatar. The correction unit corrects the virtual viewpoint video on the basis of the difference.

### Field

The present invention relates to an information processing device, an information processing method, and a program.

### BACKGROUND

There is known a volumetric capture technology to convert a real person or place into 3D data to reproduce a free viewpoint (virtual viewpoint) video. In this technique, a 3D model of a subject is generated using a plurality of real videos captured from different viewpoints. Then, a video (virtual viewpoint video) from any viewpoint is generated using the 3D model. This configuration makes it possible to generate a video from a free viewpoint regardless of the arrangement of cameras, promising application to various fields such as sports broadcasting and entertainment fields.

### CITATION LIST

### Patent Literature

Patent Literature 1: WO 2017/082076 A

### SUMMARY

### Technical Problem

A live-action 3D model of the subject is generated from videos captured by a limited number of cameras. A color and a shape of a portion whose 3D shape and texture cannot be obtained from shooting data, such as a portion corresponding to a blind spot of the camera, are estimated from the real videos to generate the live-action 3D model. A portion having a large estimation error is manually shaped, but the shaping process takes a lot of time and cost.

Therefore, the present disclosure proposes an information processing device, an information processing method, and a program which facilitate generation of a high-quality virtual viewpoint video.

### Solution to Problem

According to the present disclosure, an information processing device is provided that comprise: a virtual viewpoint video generation unit that uses shooting data of a subject captured from a plurality of viewpoints to generate a virtual viewpoint video of the subject when the subject is viewed from a virtual viewpoint; a posture estimation unit that uses the shooting data to estimate a posture of the subject; an avatar generation unit that generates an avatar model having a 3D shape of the subject corresponding to the posture, renders the avatar model based on the virtual viewpoint, and generates an avatar; an image comparison unit that extracts a difference between the virtual viewpoint video and the avatar; and a correction unit that corrects the virtual viewpoint video based on the difference. According to the present disclosure, an information processing method in which an information process of the information processing device is executed by a computer, and a program causing a computer to perform the information process of the information processing device, are provided.

### BRIEF DESCRIPTION OF DRAWINGS

FIG. 1 is an explanatory diagram of a volumetric capture technology.

FIG. 2 is a diagram illustrating a problem about a video of a blind spot portion.

FIG. 3 is diagrams illustrating an exemplary comparison between a real object and a virtual viewpoint video.

FIG. 4 is a schematic diagram of a video distribution system.

FIG. 5 is a diagram showing an exemplary configuration of a rendering server.

FIG. 6 is a diagram illustrating an exemplary configuration of a 3D scanner.

FIG. 7 is a diagram illustrating an avatar model.

FIG. 8 is a diagram illustrating an example of correction of a virtual viewpoint video based on a result of comparison with an avatar.

FIG. 9 is a diagram illustrating an exemplary method of identifying a portion to be corrected.

FIG. 10 is a diagram illustrating an exemplary method of specifying the portion to be corrected.

FIG. 11 is a flowchart illustrating an information processing method by the rendering server.

FIG. 12 is a diagram illustrating an exemplary hardware configuration of the rendering server.

### DESCRIPTION OF EMBODIMENTS

Embodiments of the present disclosure will be described in detail below with reference to the drawings. In the following embodiments, the same portions are denoted by the same reference numerals, and repetitive description thereof will be omitted.

Note that the description will be given in the following order.
[1. Volumetric capture technology]
[2. Problem about video of blind spot portion]
[3. Configuration of video distribution system]
[4. Configuration of rendering server]
[5. 3D scanning]
[6. Avatar model]
[7. Correction of virtual viewpoint video based on result of comparison with avatar]
[8. Information processing method]
[9. Hardware configuration of rendering server]
[10. Effects]

### 1. Volumetric Capture Technology

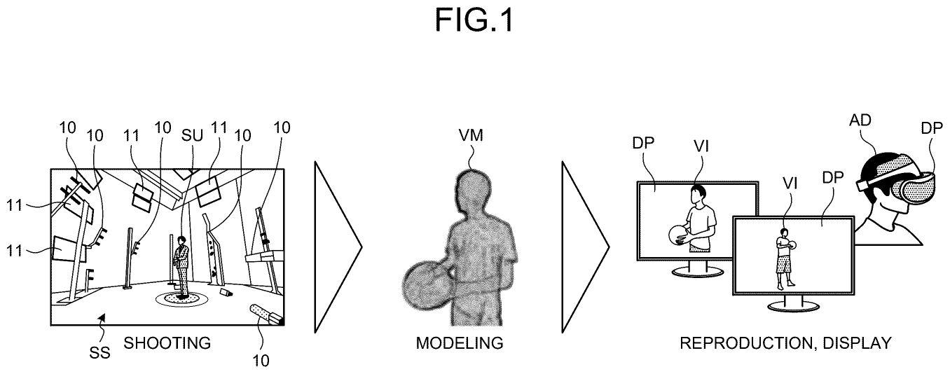

FIG. 1 is an explanatory diagram of a volumetric capture technology.

The volumetric capture technology is one of free viewpoint video technologies to capture an entire 3D space and reproduce the 3D space from a free viewpoint. Digitization of the entire 3D space instead of switching the videos captured by the plurality of cameras 10 makes it also possible to generate a video from a viewpoint where the cameras 10 do not originally positioned. Video production includes a shooting step, a modeling step, and a reproduction step.

In the shooting step, a subject SU is captured by the plurality of cameras 10. The plurality of cameras 10 is arranged to surround a shooting space SS including the subject SU. Mounting positions and mounting directions of the plurality of cameras 10 and mounting positions and mounting directions of a plurality of lighting devices 11 are appropriately set so that no blind spot occurs. The plurality of cameras 10 synchronously capture the subject SU from a plurality of viewpoints at a predetermined frame rate.

In the modeling step, a volumetric model VM of the subject SU is generated for each frame, on the basis of shooting data of the subject SU. The volumetric model VM is a 3D model that indicates a position and a posture of the subject SU at the moment of shooting. A 3D shape of the subject SU is detected by a known method such as a visual hull method and a stereo matching method.

The volumetric model VM includes, for example, geometry information, texture information, and depth information of the subject SU. The geometry information is information indicating the 3D shape of the subject SU. The geometry information is acquired as, for example, polygon data or voxel data. The texture information is information indicating the color, pattern, texture, and the like of the subject SU. The depth information is information indicating the depth of the subject SU in the shooting space SS.

In the reproduction step, a virtual viewpoint video VI is generated by rendering the volumetric model VM on the basis of viewpoint information. The viewpoint information includes information about a virtual viewpoint from which the subject SU is viewed. The viewpoint information is input by a video producer or a viewer AD. A display DP displays the virtual viewpoint video VI of the subject SU viewed from the virtual viewpoint.

### 2. Problem about video of blind spot portion

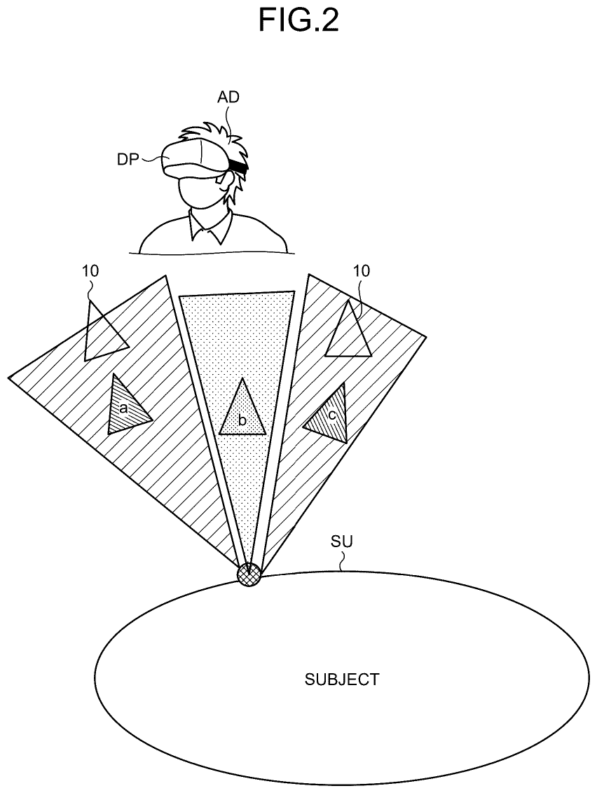

FIG. 2 is a diagram illustrating a problem about a video of a blind spot portion.

The volumetric model VM is generated on the basis of a real video, therefore, reproducing real texture of clothes and face. However, due to restrictions on the number of cameras 10 installed, installation positions of the cameras 10, and the like, sufficient shooting data may not be obtained, and accurate information about such as color and shape may not be obtained depending on the location. In this case, there is a possibility that the subject SU is not reproduced clearly and the viewer may feel strange.

For example, “a” and “b” in FIG. 2 indicate virtual viewpoints each viewed from a place where the camera 10 is positioned. In FIG. 2, “c” indicates a virtual viewpoint viewed from a place where the camera 10 is not positioned. The virtual viewpoint videos viewed from the virtual viewpoints “a” and “b” are accurately reproduced from the real videos. However, in the virtual viewpoint “c”, there is no information about the color and the shape thereof, and therefore, it is necessary to generate the virtual viewpoint video by estimating the color and the shape from a nearby real video. Therefore, an error between a real object and the virtual viewpoint video is likely to occur.

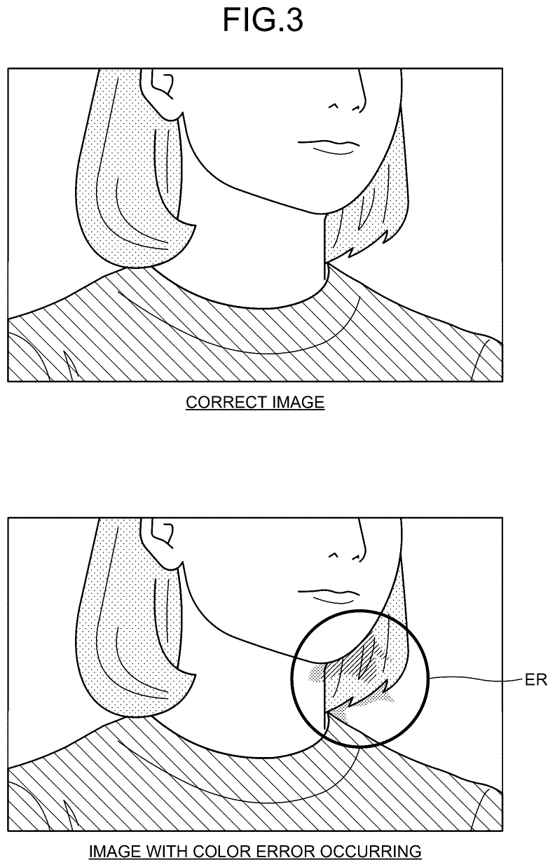

FIG. 3 is diagrams illustrating an exemplary comparison between the real object and the virtual viewpoint video.

The lower side of FIG. 3 illustrates a video from a virtual viewpoint where no camera is positioned. The upper side of FIG. 3 illustrates a real video captured from the same viewpoint as the virtual viewpoint. In the virtual viewpoint video on the lower side of FIG. 3, a lower side from the chin has a region with a color error (error region ER). The error region ER is generated at a portion where 3D data cannot be obtained from the shooting data due to the restrictions on the number of cameras 10 installed, installation positions of the cameras 10, and the like. A video of such a portion is generated by estimating the color and the shape thereof from the nearby real video (e.g., a video of the chin and hair in FIG. 3). If features of a nearby color and shape are erroneously reflected, an error may occur between the real object and the virtual viewpoint video, and the viewer AD may feel strange.

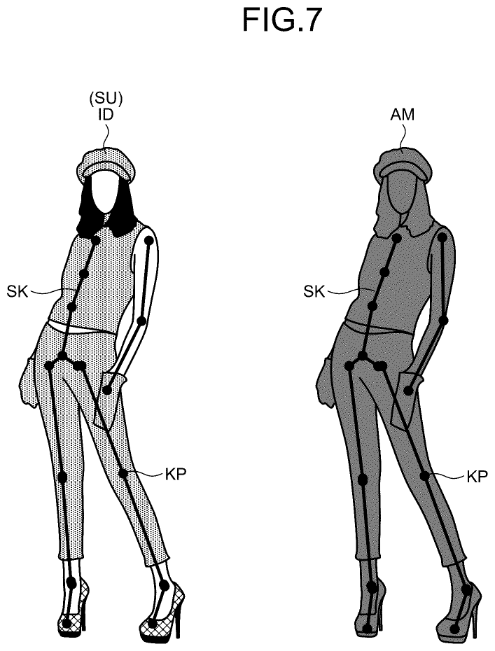

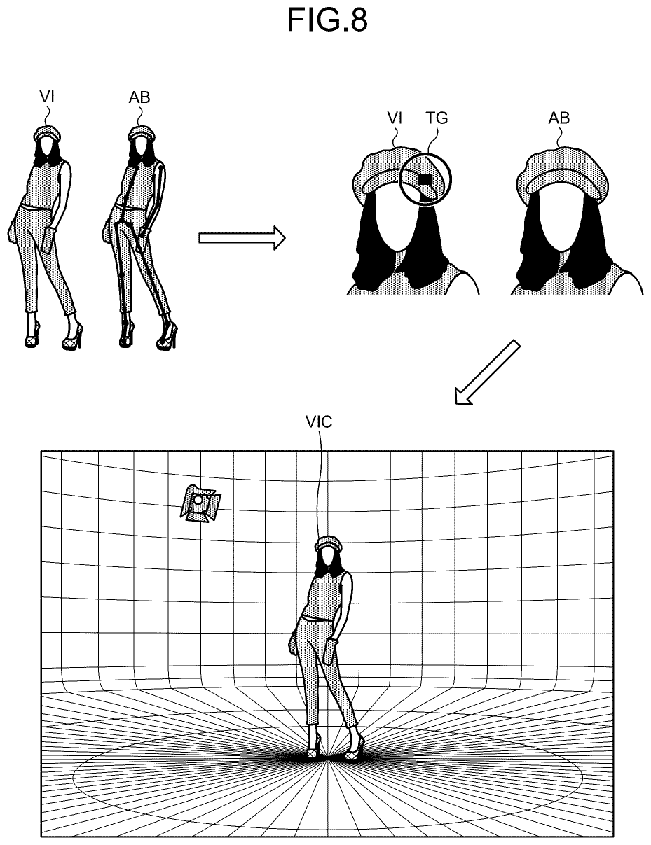

As described above, when a video of a portion that the camera 10 cannot see is generated by estimation, there is a possibility that a high-quality video cannot be obtained. Therefore, in the present disclosure, an avatar model AM (see FIG. 7) having the same posture as the subject SU caught on the camera 10 is generated on the basis of high-resolution 3D data of the subject SU prepared in advance. Rendering the avatar model AM, an avatar AB (see FIG. 8) in which the color and the shape are accurately reproduced is generated. Correcting the virtual viewpoint video VI by using information about the color and the shape of the avatar AB, the virtual viewpoint video VI of high-quality can be obtained. A method of correcting the virtual viewpoint video VI will be specifically described below.

### 3. Configuration of Video Distribution System

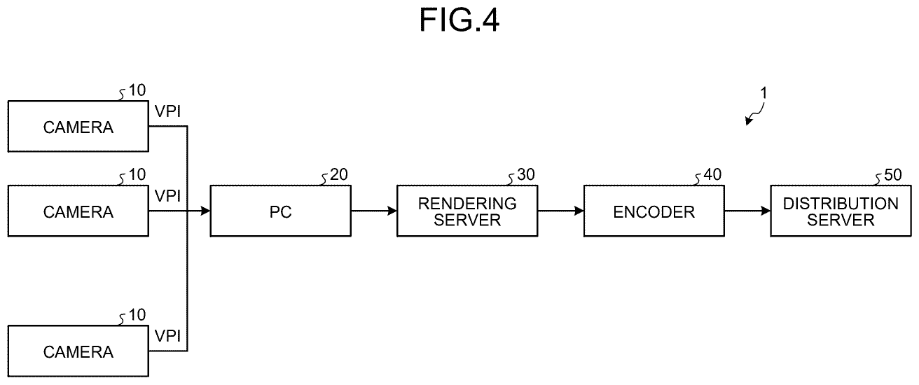

FIG. 4 is a schematic diagram of a video distribution system 1.

The video distribution system 1 is a system that distributes the virtual viewpoint video VI generated from the real video. The video distribution system 1 includes, for example, a plurality of cameras 10, a video transmission personal computer (PC) 20, a rendering server 30, an encoder 40, and a distribution server 50.

The plurality of cameras 10 outputs a plurality of viewpoint videos VPI obtained by capturing the subject SU from different viewpoints, to the video transmission PC 20. The video transmission PC 20 encodes the shooting data including the plurality of viewpoint videos VPI and transmits the shooting data to the rendering server 30. The rendering server 30 uses the plurality of viewpoint videos VPI to model the subject SU, and generates the virtual viewpoint video VI on the basis of the viewpoint information. The rendering server 30 corrects the virtual viewpoint video VI on the basis of the avatar AB, and outputs the corrected virtual viewpoint video VI (corrected video VIC) to the rendering server 30. The rendering server 30 outputs the corrected video VIC to the encoder 40. The encoder 40 encodes the corrected video VIC generated by the rendering server 30 and outputs the corrected video VIC to the distribution server 50. The distribution server 50 livestreams the corrected video VIC acquired from the encoder 40, via a network.

In the example of FIG. 4, the videos from the cameras 10 are transmitted to the rendering server 30 via the video transmission PC 20. However, when rendering is performed by the rendering server 30 installed at a shooting location, the video transmission PC 20 can be omitted. Furthermore, when live distribution is not performed, the encoder 40 and the distribution server 50 can be omitted.

### 4. Configuration of Rendering Server

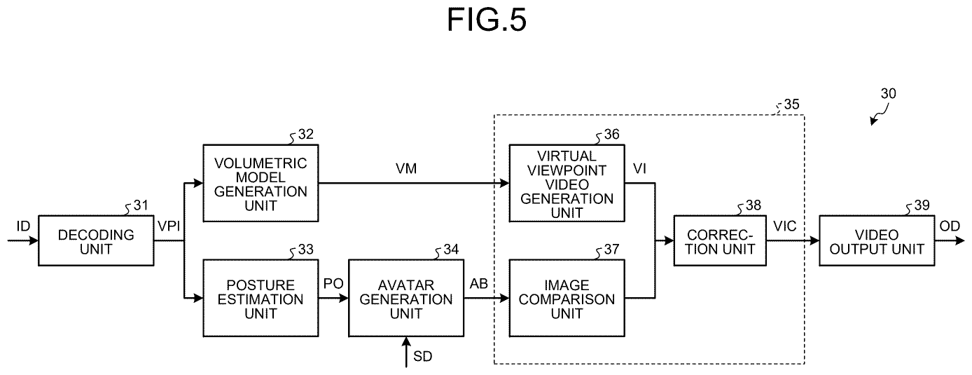

FIG. 5 is a diagram showing an exemplary configuration of the rendering server 30.

The rendering server 30 is an information processing device that processes various information including shooting data ID. The rendering server 30 includes, for example, a decoding unit 31, a volumetric model generation unit 32, a posture estimation unit 33, an avatar generation unit 34, a rendering unit 35, and a video output unit 39.

The decoding unit 31 decodes the shooting data ID transmitted from the video transmission PC 20 to acquire the plurality of viewpoint videos VPI. The decoding unit 31 outputs the plurality of viewpoint videos VPI to the volumetric model generation unit 32 and the posture estimation unit 33.

The volumetric model generation unit 32 generates the volumetric model VM of the subject SU for each frame, on the basis of the shooting data of the subject SU. For example, the volumetric model generation unit 32 uses a known method such as background subtraction to separate the subject SU from the background for each of the viewpoint videos VPI. The volumetric model generation unit 32 detects the geometry information, the texture information, and the depth information of the subject SU, from videos of the subject SU captured from a plurality of viewpoints extracted for each of the viewpoint videos VPI. The volumetric model generation unit 32 generates the volumetric model VM of the subject SU, on the basis of the detected geometry information, texture information, and depth information. The volumetric model generation unit 32 sequentially outputs the generated volumetric models VM of the respective frames to the rendering unit 35.

The posture estimation unit 33 uses the shooting data of the subject SU to estimate a posture PO of the subject SU. As a posture estimation method, a known posture estimation technology using posture estimation artificial intelligence (AI) or the like is used. The posture estimation technology is a technology to extract a plurality of key points KP (if the target is a human, a plurality of feature points indicating a shoulder, an elbow, a wrist, a waist, a knee, an ankle, and the like: see FIG. 7) from a video of a target person or a target object to estimate the posture PO of the target on the basis of relative positions between the key points KP.

The avatar generation unit 34 generates the avatar model AM having a 3D shape of the subject SU corresponding to the posture PO. For example, the avatar generation unit 34 acquires scan data SD of the subject SU obtained by performing 3D scan on the subject SU, before shooting. The scan data SD includes the geometry information and texture information of the subject SU. The avatar generation unit 34 uses the scan data SD and the posture PO to generate the avatar model AM. The avatar model AM is a 3D model of the subject SU for generating the avatar AB as a video to be compared. The avatar generation unit 34 renders the avatar model AM on the basis of the virtual viewpoint to generate the avatar AB.

### 5. 3D Scanning

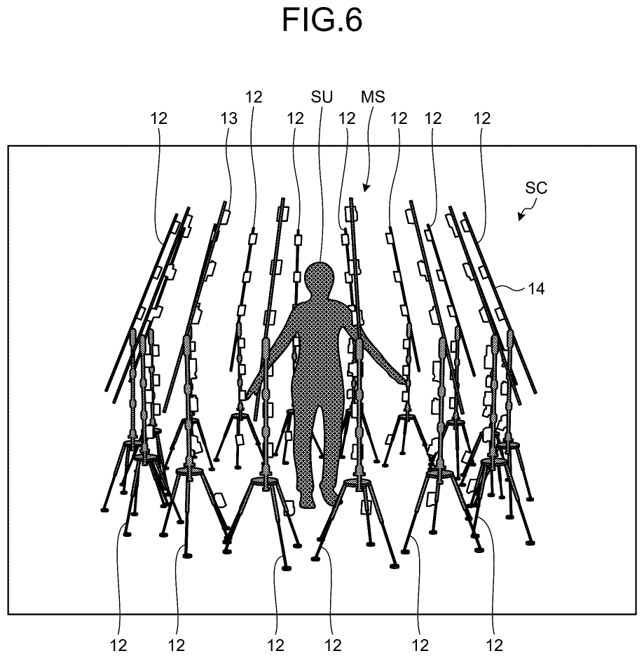

FIG. 6 is a diagram illustrating an exemplary configuration of a 3D scanner SC.

The 3D scan of the subject SU is performed using the 3D scanner SC. The 3D scanner SC includes, for example, a plurality of measurement support posts 12 annularly arranged to surround the subject SU. Each of the measurement support posts 12 includes a rod-shaped frame 14 that is arranged to extend upward by the side of the subject SU, and a plurality of cameras 13 that is mounted in the extending direction of the frame 14. A narrow, basket-shaped measurement space MS surrounding the subject SU is formed by the plurality of measurement support posts 12 arranged close to the subject SU.

The plurality of cameras 13 mounted on the plurality of measurement support posts 12 synchronously captures the subject SU from various directions. The 3D scan is performed on the subject SU who wears the same clothes as those during capture (capturing videos for generating the virtual viewpoint video VI) by the cameras 10. A subject model that includes the geometry information and the texture information of the subject SU is generated on the basis of the shooting data from the plurality of cameras 13.

A method of generating the subject model is similar to the method of generating the volumetric model VM, but the geometry information included in the scan data SD is more detailed than the geometry information included in the volumetric model VM. Therefore, when the subject model is used, the 3D shape of the subject SU can be reproduced with higher quality than when the volumetric model VM is used.

In the example of FIG. 6, a photo scanner is used as the 3D scanner SC, but the 3D scanner SC is not limited to the photo scanner. The 3D scanner SC using another scanning method, such as a laser scanner, may be used.

### 6. Avatar Model

FIG. 7 is a diagram illustrating the avatar model AM.

The posture estimation unit 33 extracts the plurality of key points KP from the shooting data ID of the subject SU. The posture estimation unit 33 estimates a skeleton SK obtained by connecting the plurality of key points KP as the posture PO of the subject SU. The avatar generation unit 34 generates the avatar model AM on the basis of the skeleton SK obtained by the posture estimation unit 33, and the scan data SD. Therefore, the subject SU has a contour generated using the avatar model AM (the contour of the avatar AB), and the contour is smoother than a contour of the subject SU in the virtual viewpoint video VI and is also small in variation over time. Therefore, correcting the virtual viewpoint video VI with the information of the avatar AB provides the corrected video VIC that is natural and less strange.

Returning to FIG. 5, the rendering unit 35 acquires the viewpoint information about a virtual viewpoint VP from the video producer or viewer AD. The rendering unit 35 renders the volumetric model VM and the avatar model AM on the basis of the viewpoint information. The rendering unit 35 includes, for example, a virtual viewpoint video generation unit 36, an image comparison unit 37, and a correction unit 38.

### 7. Correction of Virtual Viewpoint Video Based on Result of Comparison with Avatar

FIG. 8 is a diagram illustrating an example of correction of the virtual viewpoint video VI based on a result of comparison with the avatar AB.

The virtual viewpoint video generation unit 36 renders the volumetric model VM on the basis of the virtual viewpoint VP. Therefore, the virtual viewpoint video generation unit 36 generates the virtual viewpoint video VI of the subject SU when the subject SU is viewed from the virtual viewpoint VP.

The virtual viewpoint video generation unit 36 uses the shooting data ID of the actual subject SU to generate the virtual viewpoint video VI. Information (the facial expression, posture, degree of sweating, wrinkles on the clothes, wind blowing hair, and the like of the subject SU) of the subject SU during capture is reproduced directly, and therefore, it is possible to obtain a realistic video of a situation upon capture precisely reproduced. Therefore, a high sense of realism and sense of immersion can be obtained. However, the color and shape of a part the cameras 10 cannot see are generated by estimation, and therefore, a portion having a large estimation error is recognized as noise in the image. Therefore, the virtual viewpoint video VI is corrected with the information of the avatar AB separately prepared.

The correction processing is performed by using the image comparison unit 37 and the correction unit 38. The image comparison unit 37 extracts a difference between the virtual viewpoint video VI and the avatar AB. The correction unit 38 corrects the virtual viewpoint video VI on the basis of the difference between the virtual viewpoint video VI and the avatar AB.

For example, the image comparison unit 37 identifies a portion TG to be corrected on the basis of a positional relationship between the plurality of cameras 10 (viewpoints) installed in the shooting space SS and the subject SU. The image comparison unit 37 selectively extracts the difference between the virtual viewpoint video VI and the avatar AB in the portion TG to be corrected. The extracted difference includes a difference in at least one of color and shape between the virtual viewpoint video VI and the avatar AB.

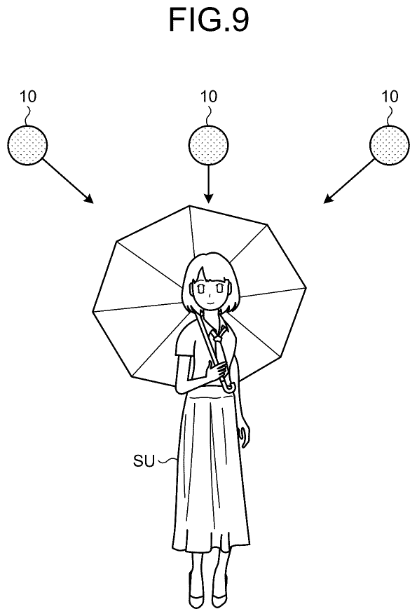

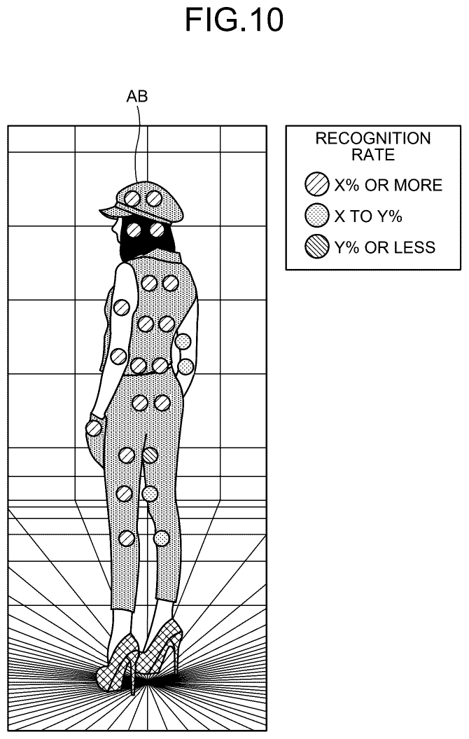

FIGS. 9 and 10 are diagrams each illustrating an exemplary method of identifying the portion TG to be corrected.

The portion TG to be corrected is identified as a portion that is difficult for the cameras 10 to recognize. In the example of FIG. 9, the subject SU holds an umbrella. The cameras 10 capture the subject SU through the umbrella, and therefore, it is difficult for the cameras 10 to recognize the portions of the head and back behind the umbrella. Therefore, the head and back of the subject SU are identified as the portion TG to be corrected.

The image comparison unit 37 determines the portion TG to be corrected on the basis of a distribution of recognition rates of the subject SU. The recognition rate means ease of recognition from a plurality of viewpoints (cameras 10). The recognition rate is calculated for each portion of the subject SU. For example, it is assumed that the total number of cameras 10 installed in the shooting space SS is N. Assuming that the number of cameras 10 that is capable of recognizing (capturing) a portion as a target (target portion) without being disturbed by an object such as the umbrella is M, the recognition rate of the target portion is calculated as M/N.

The image comparison unit 37 calculates, for each portion of the subject SU, a rate of viewpoints from which the portion is recognizable, as the recognition rate. The image comparison unit 37 identifies a portion whose recognition rate is lower than a permissible level, as the portion TG to be corrected. The permissible level is appropriately set by a system developer. In the example of FIG. 10, the recognition rates of the respective portions are classified into “X % or more ”,“ X to Y % ”, and “Y % or less ”. The portion TG to be corrected is identified as a portion having a recognition rate of “Y % or less”.

Whether the target portion is recognizable by the cameras 10 is determined, for example, on the basis of the following simulation. First, an imaginary light source (virtual light source) is installed at the position of each of the cameras 10. The avatar AB is virtually installed at the position of the subject SU, and light is emitted from the virtual light source to the avatar AB. A portion of the avatar AB to which the light is applied is calculated as an illuminated portion. A portion of the subject SU corresponding to the illuminated portion of the avatar AB is identified as a portion that is recognizable by the camera 10. A portion of the subject SU corresponding to a portion (portion behind the light) other than the illuminated portion is identified as a portion that cannot be recognized by the camera 10.

Returning to FIG. 5, the video output unit 39 converts the virtual viewpoint video VI (corrected video VIC) after correction, into a video signal and outputs the video signal as output data OD. The output data OD is transmitted to the distribution server 50 via the encoder 40.

### 8. Information Processing Method

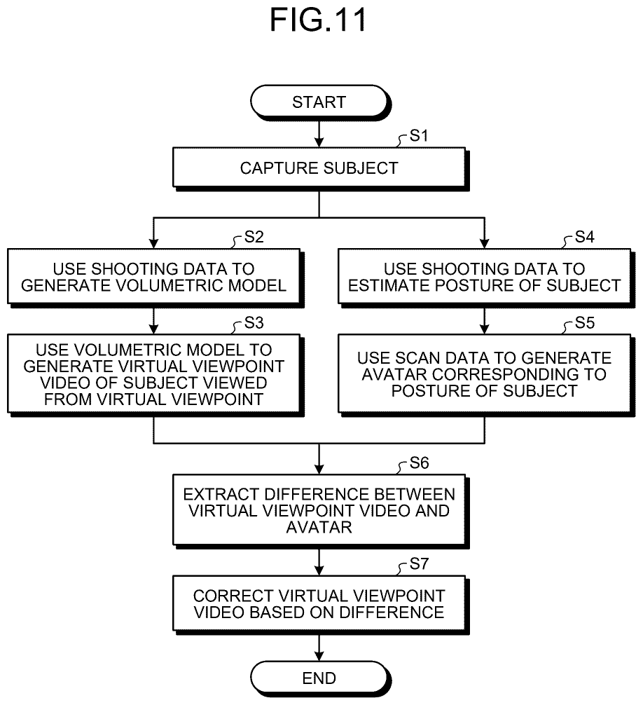

FIG. 11 is a flowchart illustrating an information processing method by the rendering server 30.

In Step S1, the plurality of cameras 10 synchronously capture the subject SU from the plurality of viewpoints. The shooting data ID including the plurality of viewpoint videos VPI captured by the plurality of cameras 10 is transmitted to the rendering server 30. The shooting data ID is supplied to the volumetric model generation unit 32 and the posture estimation unit 33 of the rendering server 30.

In Step S2, the volumetric model generation unit 32 uses the shooting data ID of the subject SU to generate the volumetric model VM of the subject SU. In Step S3, the virtual viewpoint video generation unit 36 uses the volumetric model VM to generate the virtual viewpoint video VI of the subject SU when the subject SU is viewed from the virtual viewpoint VP.

In Step S4, the posture estimation unit 33 uses the shooting data ID of the subject SU to estimate the posture PO of the subject SU. In Step S5, the avatar generation unit 34 uses the scan data SD obtained by measurement before shooting to generate the avatar model AM corresponding to the posture PO of the subject SU. The avatar generation unit 34 renders the avatar model AM on the basis of the virtual viewpoint VP to generate the avatar AB.

In Step S6, the image comparison unit 37 extracts a difference between the virtual viewpoint video VI and the avatar AB. In Step S7, the correction unit 38 corrects the virtual viewpoint video VI on the basis of the difference between the virtual viewpoint video VI and the avatar AB. The corrected virtual viewpoint video VI (corrected video VIC) is livestreamed via the distribution server 50.

### 9. Hardware Configuration of Rendering Server

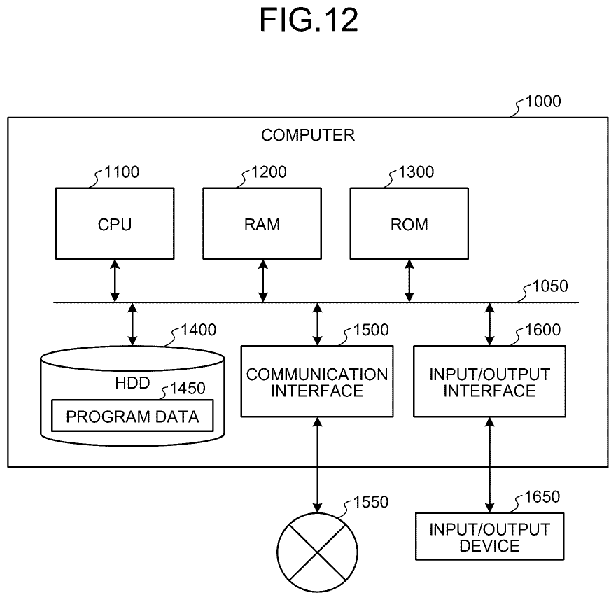

FIG. 12 is a diagram illustrating an exemplary hardware configuration of the rendering server 30.

The information processing by the rendering server 30 is implemented by, for example, a computer 1000 illustrated in FIG. 12. The computer 1000 includes a central processing unit (CPU) 1100, a random access memory (RAM) 1200, a read only memory (ROM) 1300, a hard disk drive (HDD) 1400, a communication interface 1500, and an input/output interface 1600. The respective units of the computer 1000 are connected by a bus 1050.

The CPU 1100 operates on the basis of a program (program data 1450) stored in the ROM 1300 or the HDD 1400, and controls each unit. For example, the CPU 1100 loads a program stored in the ROM 1300 or the HDD 1400 into the RAM 1200, and performs processing corresponding to each of various programs.

The ROM 1300 stores a boot program, such as a basic input output system (BIOS), executed by the CPU 1100 when the computer 1000 is booted, a program depending on hardware of the computer 1000, and the like.

The HDD 1400 is a computer-readable recording medium that non-transitorily records a program executed by the CPU 1100, data used by the program, and the like. Specifically, the HDD 1400 is a recording medium that records, as an example of the program data 1450, an information processing program according to an embodiment.

The communication interface 1500 is an interface for connecting the computer 1000 to an external network 1550 (e.g., the Internet). For example, the CPU 1100 receives data from another device or transmits data generated by the CPU 1100 to another device, via the communication interface 1500.

The input/output interface 1600 is an interface for connecting an input/output device 1650 and the computer 1000. For example, the CPU 1100 receives data from an input device such as a keyboard or mouse via the input/output interface 1600. In addition, the CPU 1100 transmits data to an output device such as a display device, speaker, or printer via the input/output interface 1600. Furthermore, the input/output interface 1600 may function as a media interface that reads a program or the like recorded on a predetermined recording medium. The medium includes, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, when the computer 1000 functions as the information processing device (rendering server 30) according to an embodiment, the CPU 1100 of the computer 1000 executes the information processing program loaded into the RAM 1200 to implement each function illustrated in FIG. 5. In addition, the HDD 1400 stores the information processing program, various models (volumetric model VM, subject model, avatar model AM), and various data (scan data SD etc.) according to the present disclosure. Note that the CPU 1100 executes the program data 1450 read from the HDD 1400, but in another example, the CPU 1100 may acquire these programs from another device via the external network 1550.

### 10. Effects

The rendering server 30 includes the virtual viewpoint video generation unit 36, the posture estimation unit 33, the avatar generation unit 34, the image comparison unit 37, and the correction unit 38. The virtual viewpoint video generation unit 36 uses the shooting data ID of the subject SU captured from the plurality of viewpoints to generate the virtual viewpoint video VI of the subject SU when the subject SU is viewed from the virtual viewpoint VP. The posture estimation unit 33 uses the shooting data ID to estimate the posture PO of the subject SU. The avatar generation unit 34 generates the avatar model AM having a 3D shape of the subject SU corresponding to the posture PO. The avatar generation unit 34 renders the avatar model AM on the basis of the virtual viewpoint VP to generate the avatar AB. The image comparison unit 37 extracts a difference between the virtual viewpoint video VI and the avatar AB. The correction unit 38 corrects the virtual viewpoint video VI on the basis of the difference. In the information processing method of the present disclosure, the processing of the rendering server 30 is executed by the computer 1000. The program of the present disclosure causes the computer 1000 to implement the processing of the rendering server 30.

According to this configuration, the avatar AB having accurate information of the subject SU is separately generated on the basis of the posture of the subject SU. By correcting the virtual viewpoint video VI on the basis of a result of comparison with the avatar AB, a high-quality virtual viewpoint video VI (corrected video VIC) is easily generated.

The image comparison unit 37 identifies the portion to be corrected, on the basis of the positional relationship between the plurality of viewpoints and the subject SU. The image comparison unit 37 selectively extracts a difference between the virtual viewpoint video VI and the avatar AB in the portion to be corrected.

According to this configuration, a load on the correction processing is reduced.

The image comparison unit 37 calculates, for each portion of the subject SU, a rate of viewpoints from which the portion is recognizable, as the recognition rate. The image comparison unit 37 identifies a portion whose recognition rate is lower than the permissible level, as the portion to be corrected.

According to this configuration, the portion to be corrected is appropriately identified.

The difference includes a color difference between the virtual viewpoint video VI and the avatar AB.

According to this configuration, the virtual viewpoint video VI with less color errors is provided.

The difference includes a shape difference between the virtual viewpoint video VI and the avatar AB.

According to this configuration, the virtual viewpoint video VI with less shape errors is provided.

The avatar generation unit 34 uses the scan data SD of the subject SU obtained, before shooting, by performing 3D scan on the subject SU to generate the avatar model AM.

According to this configuration, precise geometry information of the subject SU can be obtained by the 3D scan. Performing correction based on the precise geometry information generates the high-quality virtual viewpoint video VI.

The 3D scan is performed on the subject SU wearing the same clothes as those during capture.

According to this configuration, the avatar AB wearing the clothes matching those of the subject SU in the virtual viewpoint video VI is appropriately generated.

The contour of the subject SU generated using the avatar model AM is smoother than the contour of the subject SU in the virtual viewpoint video VI.

According to this configuration, the contour of the subject SU in the virtual viewpoint video VI is smoothly corrected on the basis of contour information of the avatar AB.

Note that the effects described herein are merely examples and are not limited to the descriptions, and other effects may be provided.

### Supplementary Note

Note that the present technology can also have the following configurations.
(1) An information processing device comprising:
   a virtual viewpoint video generation unit that uses shooting data of a subject captured from a plurality of viewpoints to generate a virtual viewpoint video of the subject when the subject is viewed from a virtual viewpoint;
   a posture estimation unit that uses the shooting data to estimate a posture of the subject;
   an avatar generation unit that generates an avatar model having a 3D shape of the subject corresponding to the posture, renders the avatar model based on the virtual viewpoint, and generates an avatar;
   an image comparison unit that extracts a difference between the virtual viewpoint video and the avatar; and
   a correction unit that corrects the virtual viewpoint video based on the difference.
(2) The information processing device according to (1), wherein
   the image comparison unit identifies a portion to be corrected based on a positional relationship between the plurality of viewpoints and the subject, and selectively extracts the difference in the portion to be corrected.
(3) The information processing device according to (2), wherein
   the image comparison unit calculates, for each portion of the subject, a rate of viewpoints from which the portion is recognizable, as a recognition rate, and identifies a portion whose recognition rate is lower than a permissible level, as the portion to be corrected.
(4) The information processing device according to any one of (1) to (3), wherein
   the difference includes a color difference between the virtual viewpoint video and the avatar.
(5) The information processing device according to any one of (1) to (4), wherein
   the difference includes a shape difference between the virtual viewpoint video and the avatar.
(6) The information processing device according to any one of (1) to (5), wherein
   the avatar generation unit uses scan data of the subject obtained, before shooting, by performing 3D scan on the subject to generate the avatar model.
(7) The information processing device according to (6), wherein
   the 3D scan is performed on the subject wearing the same clothes as those during capture.
(8) The information processing device according to (6) or (7), wherein
   a contour of the subject generated using the avatar model is smoother than a contour of the subject in the virtual viewpoint video.
(9) An information processing method executed by a computer, comprising:
   generating a virtual viewpoint video of a subject when the subject is viewed from a virtual viewpoint by using shooting data of the subject captured from a plurality of viewpoints;
   estimating a posture of the subject by using the shooting data;
   generating an avatar model having a 3D shape of the subject corresponding to the posture;
   rendering the avatar model based on the virtual viewpoint to generate an avatar;
   extracting a difference between the virtual viewpoint video and the avatar; and
   correcting the virtual viewpoint video based on the difference.
(10) A program for causing a computer to execute a process, comprising:
   generating a virtual viewpoint video of a subject when the subject is viewed from a virtual viewpoint by using shooting data of the subject captured from a plurality of viewpoints;
   estimating a posture of the subject by using the shooting data;
   generating an avatar model having a 3D shape of the subject corresponding to the posture;
   rendering the avatar model based on the virtual viewpoint to generate an avatar;
   extracting a difference between the virtual viewpoint video and the avatar; and
   correcting the virtual viewpoint video based on the difference.

### REFERENCE SIGNS LIST

30 RENDERING SERVER (INFORMATION PROCESSING DEVICE)
33 POSTURE ESTIMATION UNIT
34 AVATAR GENERATION UNIT
36 VIRTUAL VIEWPOINT VIDEO GENERATION UNIT
37 IMAGE COMPARISON UNIT
38 CORRECTION UNIT
AM AVATAR MODEL
ID SHOOTING DATA
PO POSTURE
SD SCAN DATA
SU SUBJECT
VI VIRTUAL VIEWPOINT VIDEO
VP VIRTUAL VIEWPOINT

1. An information processing device comprising:
a virtual viewpoint video generation unit that uses shooting data of a subject captured from a plurality of viewpoints to generate a virtual viewpoint video of the subject when the subject is viewed from a virtual viewpoint;
a posture estimation unit that uses the shooting data to estimate a posture of the subject;
an avatar generation unit that generates an avatar model having a 3D shape of the subject corresponding to the posture, renders the avatar model based on the virtual viewpoint, and generates an avatar;
an image comparison unit that extracts a difference between the virtual viewpoint video and the avatar; and
a correction unit that corrects the virtual viewpoint video based on the difference.

2. The information processing device according to claim 1, wherein
the image comparison unit identifies a portion to be corrected based on a positional relationship between the plurality of viewpoints and the subject, and selectively extracts the difference in the portion to be corrected.

3. The information processing device according to claim 2, wherein
the image comparison unit calculates, for each portion of the subject, a rate of viewpoints from which the portion is recognizable, as a recognition rate, and identifies a portion whose recognition rate is lower than a permissible level, as the portion to be corrected.

4. The information processing device according to claim 1, wherein
the difference includes a color difference between the virtual viewpoint video and the avatar.

5. The information processing device according to claim 1, wherein
the difference includes a shape difference between the virtual viewpoint video and the avatar.

6. The information processing device according to claim 1, wherein
the avatar generation unit uses scan data of the subject obtained, before shooting, by performing 3D scan on the subject to generate the avatar model.

7. The information processing device according to claim 6, wherein
the 3D scan is performed on the subject wearing the same clothes as those during capture.

8. The information processing device according to claim 6, wherein
a contour of the subject generated using the avatar model is smoother than a contour of the subject in the virtual viewpoint video.

9. An information processing method executed by a computer, comprising:
generating a virtual viewpoint video of a subject when the subject is viewed from a virtual viewpoint by using shooting data of the subject captured from a plurality of viewpoints;
estimating a posture of the subject by using the shooting data;
generating an avatar model having a 3D shape of the subject corresponding to the posture;
rendering the avatar model based on the virtual viewpoint to generate an avatar;
extracting a difference between the virtual viewpoint video and the avatar; and
correcting the virtual viewpoint video based on the difference.

10. A program for causing a computer to execute a process, comprising:
generating a virtual viewpoint video of a subject when the subject is viewed from a virtual viewpoint by using shooting data of the subject captured from a plurality of viewpoints;
estimating a posture of the subject by using the shooting data;
generating an avatar model having a 3D shape of the subject corresponding to the posture;
rendering the avatar model based on the virtual viewpoint to generate an avatar;
extracting a difference between the virtual viewpoint video and the avatar; and
correcting the virtual viewpoint video based on the difference.
